(19) United States
(12) Patent Application Publication
(10) Pub. No.: US 2015/0340846 A1
(43) Pub. Date: Nov. 26, 2015

(54) DETECTION SYSTEM FOR DETERMINING SPARK VOLTAGE

(71) Applicant: Caterpillar Inc., Peoria, IL (US)

(72) Inventors: James Michael Schultz, Chillicothe, IL (US); Dustin Dale Denning, Chillicothe, IL (US); William Eugene Hoban, JR., Dunlap, IL (US)

(73) Assignee: Caterpillar Inc., Peoria, IL (US)

(21) Appl. No.: 14/283,550

(22) Filed: May 21, 2014

(51) Int. Cl. H01T 13/60; F02P 17/12; F02P 17/02

(52) U.S. Cl. CPC H01T 13/60; F02P 17/02; F02P 17/12; F02P 2017/121

(57) ABSTRACT

A detection system for determining spark voltage of a spark plug in a capacitive discharge ignition system is disclosed. The detection system may have a sensor circuit configured to detect occurrence of a spark by measuring a voltage on a low side of a primary coil. The detection system may also have an electronic control unit connected to the sensor circuit. The electronic control unit may be configured to receive a signal from the sensor circuit indicating that the voltage exceeded a threshold. The electronic control unit may be further configured to determine a spark time based on the signal, and determine a spark voltage based on the spark time.

### TECHNICAL FIELD

The present disclosure is directed to detection system and, more particularly, to a detection system for determining spark voltage.

### BACKGROUND

Many engines, including gasoline engines, gaseous-fuel engines, and dual-fuel engines, include an ignition system for igniting an air/fuel mixture to produce heat, which may be used to produce mechanical power. Some ignition systems include a spark plug that produces a spark that ignites the air/fuel mixture. An electrical device, such as an ignition coil, outputs high voltage electricity to the spark plug for use in generating the spark. In some engines, a detection system measures various parameters of the ignition system as the engine operates. An electronic control unit (ECU) and/or a machine operator may use information output by the detection system to monitor engine operation and/or to determine when maintenance is required (e.g., a spark plug needs replaced). For example, the ECU may determine spark voltage (i.e., voltage of a spark plug electrode just prior to a spark being produced), which may be an indicator of the useful life remaining for a spark plug.

In previous detection systems, an ECU may estimate spark voltage based on a measurement of a primary current rise time, such as the amount of time required for current in a primary coil of an ignition coil to rise from approximately 0% to 100% of its final value during an ignition cycle. While this method may give some indication of spark voltage, it has limitations. For example, non-linear characteristics of a rising current may cause spark voltage to be estimated inaccurately. In addition, certain adverse conditions, such as multi-arc conditions (e.g., occurrence of multiple sparks from one spark plug during one ignition cycle), conditions causing abnormally low or high spark voltage, high engine load, and/or combustion turbulence, may also cause inaccuracies. Inaccurate estimations of spark voltage may lead to inefficient use of spark plugs. For example, a spark plug may be replaced well before it is necessary to do so.

One example of an attempt to determine spark voltage without using primary current rise time is disclosed in U.S. Pat. No. 6,492,818, that issued to Downs on Dec. 10, 2002 (“the '818 patent”). In particular, the detection system of the '818 patent includes a spark detection circuit that is responsive to a reflected spark event from a secondary coil to the primary coil. The detection system determines a time difference between an onset of capacitive discharge and occurrence of the reflected spark event. A processing circuit may use this time difference to determine spark voltage. While the detection system of the '818 patent uses an alternative to measuring primary current rise time to determine spark voltage, it may be less than ideal. In particular, the '818 patent does not address spark detection under certain adverse conditions, and therefore, the detection system may not be configured to determine spark voltage consistently.

The present disclosure is directed to overcoming one or more of the problems set forth above and/or other problems of the prior art.

### SUMMARY

In one aspect, the present disclosure is directed to a method for determining spark voltage of a spark plug in a capacitive discharge ignition system. The method may include measuring a voltage on a low side of a primary coil. The method may also include determining a spark time based on the voltage. The method may further include determining a spark voltage based on the spark time.

In another aspect, the present disclosure is directed to a detection system for determining spark voltage of a spark plug in a capacitive discharge ignition system. The detection system may include a sensor circuit configured to detect occurrence of a spark by measuring a voltage on a low side of a primary coil. The detection system may also include an electronic control unit connected to the sensor circuit. The electronic control unit may be configured to receive a signal from the sensor circuit indicating that the voltage exceeded a threshold. The electronic control unit may be further configured to determine a spark time based on the signal, and determine a spark voltage based on the spark time.

### BRIEF DESCRIPTION OF THE DRAWINGS

FIG. 1 is a schematic illustration of an exemplary disclosed engine;

FIG. 2 is a schematic illustration of an exemplary disclosed detection system that may be used in conjunction with the engine of FIG. 1;

FIG. 3 is a schematic illustration of a sensor circuit that may be used in conjunction with the detection system of FIG. 2;

FIGS. 4 and 5 are waveforms depicting secondary voltage versus time and primary coil rise time versus time for exemplary ignition cycles; and

FIGS. 6 and 7 are waveforms depicting secondary voltage and sensor circuit output versus time for exemplary ignition cycles.

### DETAILED DESCRIPTION

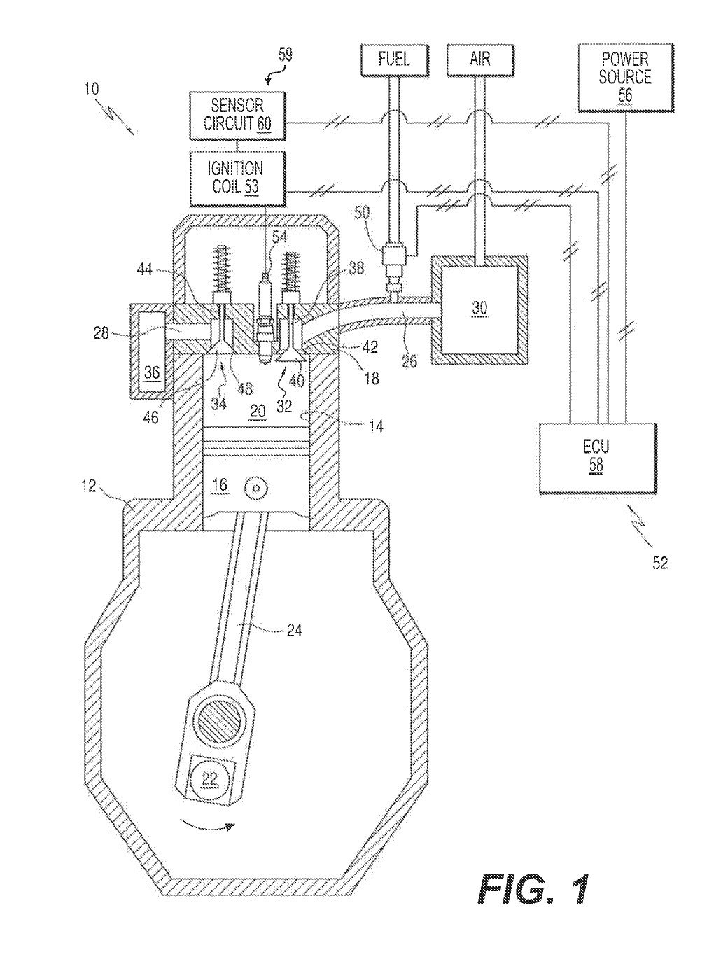

FIG. 1 illustrates an exemplary combustion engine 10. For the purposes of this disclosure, engine 10 will be described as a four-stroke gaseous-fueled engine, for example a natural gas engine. One skilled in the art will recognize, however, that engine 10 may be any other type of combustion engine such as, for example, a gasoline or a dual-fuel engine. Engine 10 may include an engine block 12 that at least partially defines one or more cylinders 14 (only one shown in FIG. 1). A piston 16 may be slidably disposed within each cylinder 14 to reciprocate between a top-dead-center (TDC) position and a bottom-dead-center (BDC) position, and a cylinder head 18 may be associated with each cylinder 14. Cylinder 14, piston 16, and cylinder head 18 may together define a combustion chamber 20. It is contemplated that engine 10 may include any number of combustion chambers 20 and that combustion chambers 20 may be disposed in an “in-line” configuration, a “V” configuration, or in any other suitable configuration.

Engine 10 may also include a crankshaft 22 that is rotatably disposed within engine block 12. A connecting rod 24 may connect each piston 16 to crankshaft 22 so that a sliding motion of piston 16 between the TDC and BDC positions within each respective cylinder 14 results in a rotation of crankshaft 22. Similarly, a rotation of crankshaft 22 may result in a sliding motion of piston 16 between the TDC and BDC positions. In a four-stroke engine, piston 16 may reciprocate between the TDC and BDC positions through an intake stroke, a compression stroke, a combustion or power stroke, and an exhaust stroke. It is also contemplated that engine 10 may alternatively be a two-stroke engine, wherein a complete cycle includes a compression/exhaust stroke (BDC to TDC) and a power/exhaust/intake stroke (TDC to BDC).

Cylinder head 18 may define an intake passageway 26 and an exhaust passageway 28. Intake passageway 26 may direct compressed air or an air and fuel mixture from an intake manifold 30, through an intake opening 32, and into combustion chamber 20. Exhaust passageway 28 may similarly direct exhaust gases from combustion chamber 20, through an exhaust opening 34, and into an exhaust manifold 36.

An intake valve 38 having a valve element 40 may be disposed within intake opening 32 and configured to selectively engage a seat 42. Valve element 38 may be movable between a first position, at which valve element 40 engages seat 42 to inhibit a flow of fluid relative to intake opening 32, and a second position, at which valve element 40 is removed from seat 42 to allow the flow of fluid.

An exhaust valve 44 having a valve element 46 may be similarly disposed within exhaust opening 34 and configured to selectively engage a seat 48. Valve element 46 may be movable between a first position, at which valve element 46 engages seat 48 to inhibit a flow of fluid relative to exhaust opening 34, and a second position, at which valve element 46 is removed from seat 48 to allow the flow of fluid.

A series of valve actuation assemblies (not shown) may be operatively associated with engine 10 to move valve elements 40 and 46 between the first and second positions. It should be noted that each cylinder head 18 could include multiple intake openings 32 and multiple exhaust openings 34. Each such opening would be associated with either an intake valve element 40 or an exhaust valve element 46. Engine 10 may include a valve actuation assembly for each cylinder head 18 that is configured to actuate all of the intake valves 38 or all of the exhaust valves 44 of that cylinder head 18. It is also contemplated that a single valve actuation assembly could actuate the intake valves 38 or the exhaust valves 44 associated with multiple cylinder heads 18, if desired. The valve actuation assemblies may embody, for example, a cam/push-rod/rocker arm arrangement, a solenoid actuator, a hydraulic actuator, or any other means for actuating known in the art.

A fuel injection device 50 may be associated with engine 10 to direct pressurized fuel into combustion chamber 20. Fuel injection device 50 may embody, for example, an electronic valve situated in communication with intake passageway 26. It is contemplated that injection device 50 could alternatively embody a hydraulically, mechanically, or pneumatically actuated injection device that selectively pressurizes and/or allows pressurized fuel to pass into combustion chamber 20 via intake passageway 26 or in another manner (i.e., directly). The fuel may include a compressed gaseous fuel such as, for example, natural gas, propane, bio-gas, landfill gas, or hydrogen. It is also contemplated that the fuel may be liquefied, for example, gasoline, diesel, methanol, ethanol, or any other liquid fuel, and that an onboard pump (not shown) may be required to pressurize the fuel.

The amount of fuel allowed into intake passageway 26 by injection device 50 may be associated with a ratio of fuel-to-air introduced into combustion chamber 20. Specifically, if it is desired to introduce a lean mixture of fuel and air (mixture having a relatively low amount of fuel compared to the amount of air) into combustion chamber 20, injection device 50 may remain in an injecting position for a shorter period of time (or otherwise be controlled to inject less fuel per given cycle) than if a rich mixture of fuel and air (mixture having a relatively large amount of fuel compared to the amount of air) is desired. Likewise, if a rich mixture of fuel and air is desired, injection device 50 may remain in the injecting position for a longer period of time (or otherwise be controlled to inject more fuel per given cycle) than if a lean mixture is desired.

An ignition system 52 may be associated with engine 10 to help regulate the combustion of the fuel and air mixture within combustion chamber 20 during a series of ignition sequences. In an exemplary embodiment, ignition system 52 may be a capacitive discharge ignition system, although other systems are possible. Ignition system 52 may include any known ignition components, such as an ignition coil 53, an spark plug 54, one or more auxiliary injectors (not shown), a power source 56, and an electronic control unit (ECU) 58. ECU 58 may be configured to regulate operation of such ignition system components based on a stored control strategy and/or in response to input received from a sensor circuit 60.

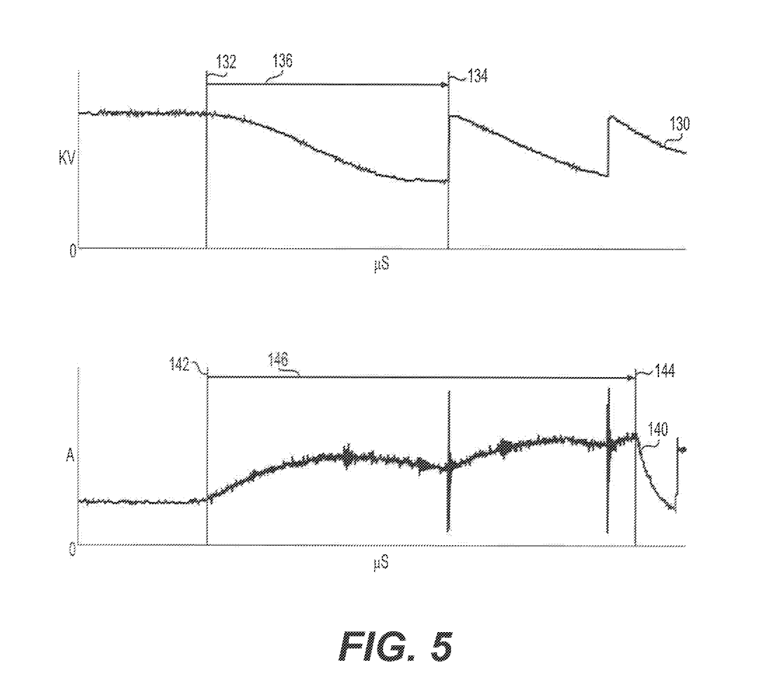

Ignition coil 53 may be operatively connected, electrically coupled, in communication, and/or otherwise associated with the ECU 58, spark plug 54, and/or power source 56. The ignition coil 53 may be a separate component of the ignition system 52 or, in additional exemplary embodiments, the ignition coil 53 may be a component of the spark plug 54 or other electrical devices included in the ignition system 52. The ignition coil 53 may comprise an inductor, a capacitor, and/or other like electrical devices configured to store electrical energy until such energy is controllably released. Such energy storage and/or discharge characteristics of the ignition coil may result in the characteristics of the waveforms illustrated in FIGS. 4-7.

Spark plug 54 may facilitate ignition of the fuel and air mixture within combustion chamber 20 during each ignition sequence. Specifically, to initiate combustion of the fuel and air mixture during a startup event or during operation of engine 10, spark plug 54 may generate a spark that locally heats the mixture, thereby creating a flame that propagates throughout combustion chamber 20. The spark plug 54 may produce a spark, for example, after a flow of primary electrical current is directed to the ignition coil 53 at a desired voltage. As the combustion process progresses, the temperature within combustion chamber 20 may continue to rise to a level that supports efficient auto-ignition of the mixture. It should be understood that spark plug 54 may alternatively be another type of igniter known in the art.

Power source 56 may be operably connected to the ECU 58 and configured to supply energy to one or more components of the ignition system 52 and/or other engine components discussed herein. In an exemplary embodiment, power source 56 may be a constant voltage, direct current source such as a battery or other like device. In such embodiments, the power source 56 may embody the battery of the vehicle to which the engine 10 is connected. In alternative exemplary embodiments, however, the power source 56 may be separate from the vehicle battery and may be, for example, dedicated to supplying power to the ignition system 52. In still further exemplary embodiments, the power source 56 may be an alternating current source of electrical energy. The power source 56 may be configured to direct any desired voltage to the components of the ignition system 52 to facilitate operation thereof, and such voltage may be increased and/or decreased by one or more convertors, stepper circuits, amplification circuits, and/or other like electrical components.

ECU 58 may embody a single or multiple microprocessors, field programmable gate arrays (FPGAs), digital sipal processors (DSPs), etc., that include a means for controlling an operation of engine 10 and/or individual engine components. For example, ECU 58 may be configured to control the ignition system 52 and/or a detection system 59, based upon a control program stored in a memory of the ECU 58. Numerous commercially available microprocessors can be configured to perform the functions of ECU 58. It should be appreciated that ECU 58 could readily embody a general engine microprocessor capable of controlling numerous system functions and modes of operation. Various other known circuits may be associated with ECU 58, including power source circuitry, signal-conditioning circuitry, actuator driver circuitry circuitry powering solenoids, motors, or piezo actuators), communication circuitry, timer circuitry, and other appropriate circuitry.

Detection system 59 may include one or more detection, measurement, monitoring, and/or processing components configured to detect one or more parameters associated with ignition system 42. In an exemplary embodiment, detection system 59 may include one or more of the components of ignition system 52 and a sensor circuit 60. For example, detection system 59 may include ECU 58 and sensor circuit 60. In an exemplary embodiment, sensor circuit 60 may be operably coupled to ECU 58 and ignition coil 53 and configured to detect, measure, sense and/or monitor one or more parameters associated with ignition system 52. For example, sensor circuit 60 may be configured to measure voltage and/or current associated with ignition coil 53 and/or one or more circuits and or electrical connections between ignition coil 53 and power source 56. In some embodiments, sensor circuit 60 may be an integral component of ignition coil 53. Sensor circuit 60 may be electronically connected to ECU 58 such that ECU 58 may send and receive signals from sensor circuit 60.

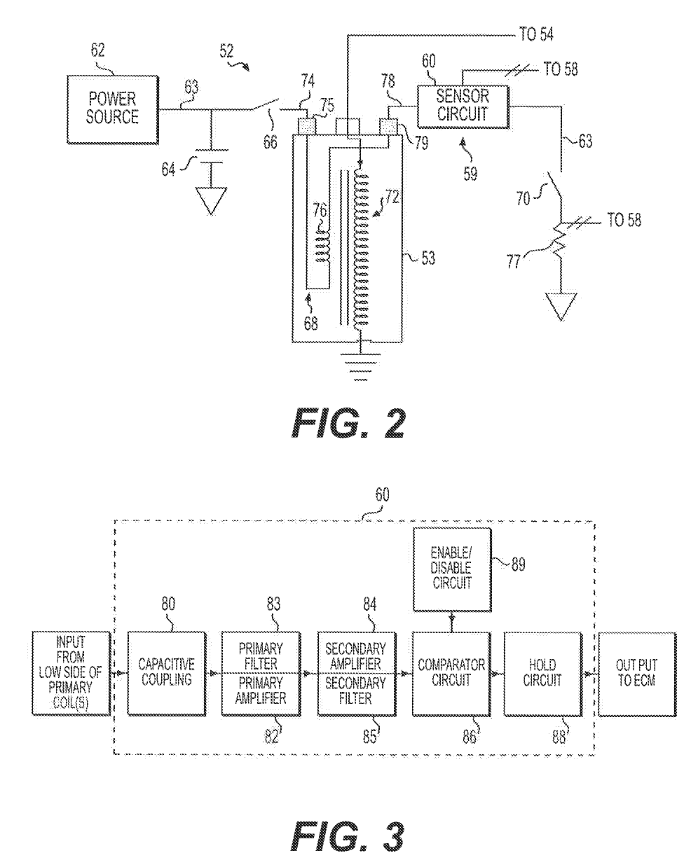

FIG. 2 depicts certain components of ignition system 52 and detection system 59 in more detail. In an exemplary embodiment, a power source 62, which may be the same as or different from power source 56, supplies AC or DC electricity to an ignition driver circuit 63. In some embodiments, power source 56 may include or be connected to a convertor configured to convert the electricity into a form suitable for ignition driver circuit 63. Ignition driver circuit 63 may be connected to ignition coil 53 and include a high side 74 separated from a low side 78 by ignition coil 53.

High side 74 may include a capacitor 64 connected to power source 62. Capacitor 64 may be a high-voltage supply capacitor configured to store electrical energy received from power source 56. High side 74 may also include a high side switch 66 connected between capacitor 64 and ignition coil 53. High side switch 66, which may be controlled by ECU 58, may be an ignition switch configured to open and close to selectively complete a circuit between capacitor 64 and ignition coil 53. In addition, during an ignition cycle, high side switch 66 may open and close to modulate current in driver circuit 63 between an upper threshold and a lower threshold.

High side 74 may lead to a primary coil 68 of ignition coil 53, such as through a high side pin 75. Primary coil 68 may include primary windings 76 connected between high side 74 and low side 78. As shown in FIG. 2, primary coil 68 may lead to low side 78 of ignition driver circuit 63, such as through a low side pin 79.

Low side 78 may include a low side switch 70 and current sensing resistor 77. Low side switch 70 may be a switch configured to open and close to selectively allow current to flow through driver circuit 63 and, therefore, voltage to build in secondary coil 72. Secondary coil 72 may direct the high voltage to spark plug 54 for generation of a spark. Current sensing resistor 77 may be configured to measure a current in driver circuit 63 and connected to provide a current signal to ECU 58.

Low side 78 may also include sensor circuit 60. Sensor circuit 60 may be configured to measure a voltage of primary coil 68 on low side 78. In some embodiments, sensor circuit 60 may be connected between primary windings 76 and low side switch 70. For example, sensor circuit 60 may be directly connected to low side pin 79, in another embodiment, sensor circuit 60 may be connected on the other side of low side switch 70, near current sensing resistor 77, to measure a voltage in the vicinity of current sensing resistor 77. For example, sensor circuit 70 may be connected directly at current sensing resistor 77.

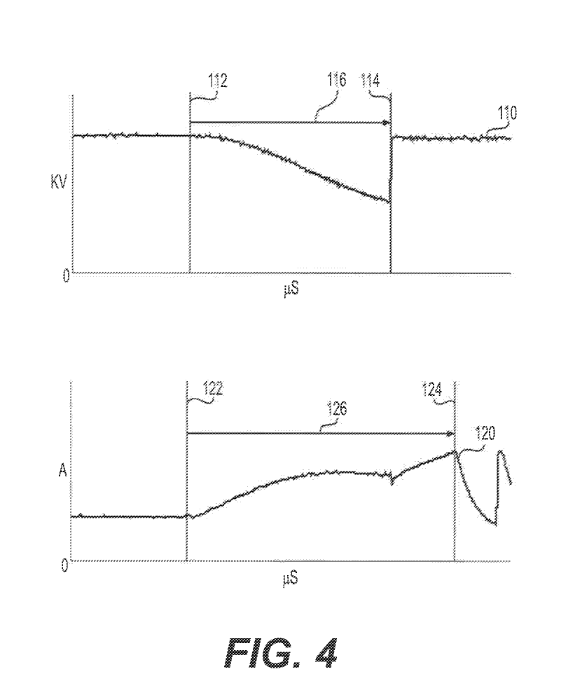

FIG. 3 schematically depicts an exemplary embodiment of sensor circuit 60. As shown in FIG. 3, sensor circuit 60 may be connected to receive input from a low side 78 of at least one primary coil 68. In some embodiments, sensor circuit 60 may receive input from a plurality of primary coils 68, associated with a plurality of ignition coils 53 and/or spark plugs 54. In this way, a single sensor circuit 60 may measure a voltage of more than one primary coil 68. In an exemplary embodiment, the input received by sensor circuit 60 is a voltage signal.

Sensor circuit 60 may include a capacitive coupling 80 configured to receive the voltage signals from the primary coils 68. In an exemplary embodiment, capacitive coupling 80 may be configured to isolate the input from one of the connected primary coils, such that only a voltage signal from one primary coil 68 is measured at a time. ECU 58 may later determine which primary coil 68 is associated with a particular voltage signal that passes through sensor circuit 60.

Capacitive coupling 80 may direct a received voltage signal to a plurality of amplifiers and filters. For example, a voltage signal may pass through a primary amplifier 82, a primary filter 83, a secondary amplifier 84, and a secondary filter 85. Primary amplifier 82 and secondary amplifier 84 may be any known signal amplifiers configured to modulate or otherwise alter a voltage signal. Primary filter 83 and/or secondary filter 85 may be a high-pass filter, low-pass filter, a combination, and/or other type of filter known in the art.

After passing through the amplifiers and filters, the voltage signal may be directed to a comparator circuit 86 and a hold circuit 88. Comparator circuit 86 may include any known circuit components configured to compare a received voltage signal value (e.g., amplitude) to another value. For example, comparator circuit 86 may compare a current voltage signal value with a fixed threshold value. In another example, comparator circuit 86 may compare a current voltage signal with a previous voltage signal value to determine a change in voltage, and compare the difference to a threshold value. If the current voltage signal value or the difference between the current value and the previous value exceeds the respective threshold value, comparator circuit 86 may output a signal pulse to hold circuit 88. An enable/disable circuit 89 may be connected to comparator circuit 86 and ECU 58 to allow ECU 58 to selectively enable and disable sensor circuit 60.

Hold circuit 88 may monitor signal pulses from comparator circuit 86 and direct an output signal to ECU 58, the output signal indicating each time that a signal pulse was received. In this way, sensor circuit 60 may provide an output signal to ECU 58 to indicate a time that a voltage spike was detected. Therefore, since occurrence of a spark causes a voltage spike in an associated primary coil 68, sensor circuit 60 may be configured to provide an output signal that ECU 58 may use to determine a time at which a spark occurs.

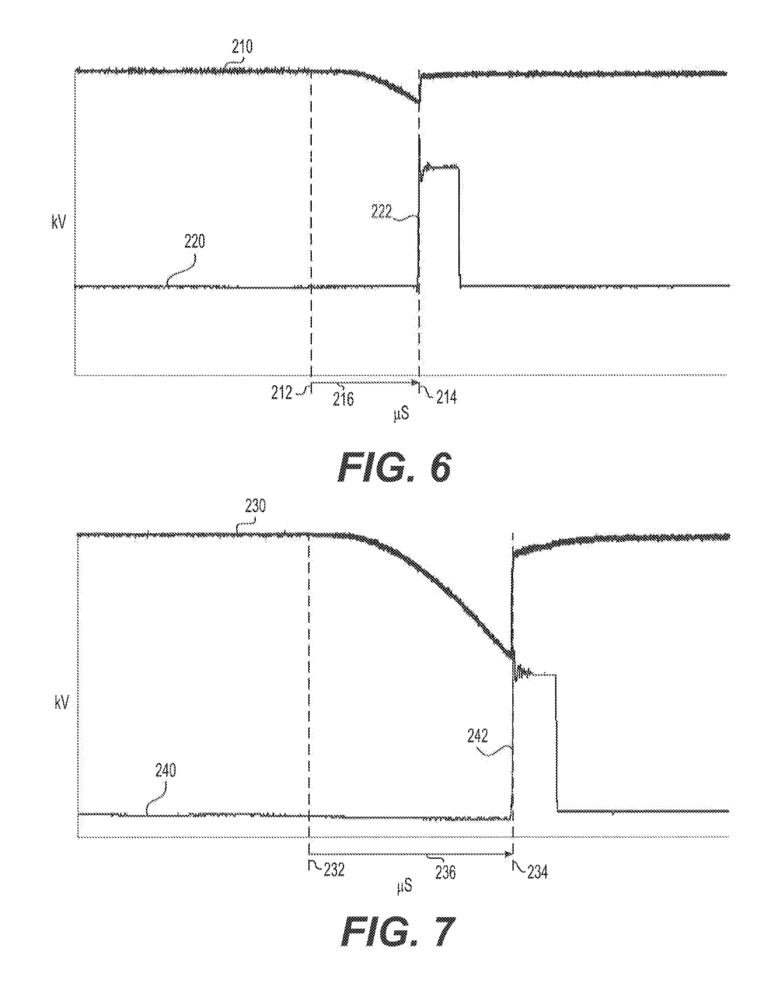

FIGS. 4-7 depict waveforms associated with exemplary ignition cycles associated with ignition system 52 and detection system 59. In particular, FIG. 4 depicts secondary voltage and primary current waveforms associated with operation of ignition system 52 under normal conditions. FIGS. 5-7 depict waveforms associated with operation of ignition system 52 under adverse conditions. As used herein, “adverse conditions” may refer to adverse operating conditions (e.g., combustion turbulence, high engine loads) and/or adverse measurement conditions (e.g., new spark plug that produces a spark at a relatively low voltage), in particular, FIG. 5 depicts secondary voltage and primary current waveforms associated with a multi-arc condition. FIG. 6 depicts secondary voltage and sensor circuit 60 output waveforms associated with a low spark voltage condition. FIG. 7 depicts secondary voltage and sensor circuit 60 output waveforms associated with a high spark voltage condition.

### INDUSTRIAL APPLICABILITY

The exemplary disclosed detection system may be applicable to any ignition system that includes a spark igniter, providing a more robust and consistent system for measuring one or more parameters associated with a spark plug and/or ignition coil (e.g., generation of a spark during an ignition cycle). In particular, the exemplary disclosed sensor circuit, which is configured to measure primary coil voltage on a low side of the primary coil, consistently detects the occurrence of a spark by detecting the time at which the spark occurs. Consistent detection of a spark allows for a more accurate determination of spark plug condition. In this way, engine maintenance (e.g., spark plug replacement) may be carried out more efficiently. The operation of engine 10, ignition system 52, and detection system 59, as well as exemplary waveforms that may be observed as a result, are described in more detail below.

During an intake stroke of the engine 10 shown in FIG. 1, as piston 16 is moving within combustion chamber 20 between the TDC position and the BDC position, intake valve 38 may be in the first position, as shown in FIG. 1. During the intake stroke, the downward movement of piston 16 towards the BDC position may create a low-pressure condition within combustion chamber 20. The low-pressure condition may act to draw fuel and air from intake passageway 26 into combustion chamber 20 via intake opening 32. A turbocharger may alternatively be used to force compressed air and fuel into combustion chamber 20. The fuel may be introduced into the air stream either upstream or downstream of the turbocharger or, alternatively, may be injected directly into combustion chamber 20. It is contemplated that the fuel may alternatively be introduced into combustion chamber 20 during a portion of the compression stroke, if desired.

Following the intake stroke, both intake valve 38 and exhaust valve 44 may be in the second position at which the fuel and air mixture is blocked from exiting combustion chamber 20 during the ensuing upward compression stroke of piston 16. As piston 16 moves upward, from the BDC position towards the TDC position during the compression stroke, the fuel and air within combustion chamber 20 may be mixed and compressed. At a time during the compression stroke or, alternatively, just after completion of the compression stroke, combustion of the compressed mixture may be initiated, including ignition system 52 starting an ignition cycle.

ECU 58 may initiate an ignition cycle (and thereby combustion) by energizing one or more components of the ignition system 52, such as the ignition coil 53 and/or the spark plug 54. For example, ECU 58 may direct an electrical current from the power source 62 to ignition coil 53 in order to generate a spark at spark plug 54 to locally heat the now compressed fuel and air mixture. This local heating may result in a flame that propagates throughout combustion chamber 20, thereby selectively igniting the remaining fuel and air mixture within the engine 10.

In particular, ECU 58 may initiate an ignition cycle by communicating with ignition driver circuit 63 to close one or more of high side switch 66 and low side switch 70, completing driver circuit 63. Completion of driver circuit 63 may cause increasing current throughout driver circuit 63 and high voltage to build in secondary coil 72. The high voltage may be directed to an electrode of spark plug 54, which may cause a voltage difference between the electrode and a grounded electrode sufficient to cause a spark in combustion chamber 20 (e.g., voltage increases until a spark occurs).

In addition, as current is increasing in driver circuit 63, current sensing resistor 77 may output a signal to provide ECU 58 with a current measurement. ECU 58 may monitor the current measurement and send a signal to open high side switch 66 when current reaches an upper threshold level. ECU 58 may continue to monitor current and re-close high side switch 66 when current reaches a lower threshold level. ECU 58 may thereafter open and close high side switch 66 in this manner to modulate current in driver circuit 63 (such as to sustain a spark across a corresponding spark gap, minimize charge dissipation from capacitor 64, prevent current from reaching an undesired level, etc.).

After an ignition cycle is completed, one or more of high side switch 66 and low side switch 70 may be open until the next ignition cycle is initiated. ECU 58 may control each ignition coil 53 associated with engine 10 in this manner and in accordance with a control strategy and/or engine timing, resulting in conventional operation of engine 10 (e.g., to produce mechanical output).

During one or more ignition cycles of ignition system 52, detection system 59 may operate to measure and/or detect a voltage signal at low side 78 of primary coil 68. Detection system 59 may measure a voltage signal of primary coil 68 in order to detect the time at which a spark occurs during the ignition cycle. A spark may be detected in a primary coil voltage signal because, at the time that a spark occurs, a voltage spike is reflected from secondary coil 72 to primary coil 68. Sensor circuit 60 may be configured to detect this voltage spike and output a signal pulse when it occurs.

As has been described, sensor circuit 60 may be connected on low side 78 of primary coil 68 and receive a voltage signal as ignition coil 53 operates during an ignition cycle. Capacitive coupling 80 may receive voltage signals from multiple primary coils 68, maintaining each voltage separately from each other to facilitate individual measuring of each signal. Capacitive coupling 80 may direct the voltage signal through primary amplifier 82, a primary filter 83, a secondary amplifier 84, and a secondary filter 85 to focus the measurement on a particular portion of the voltage signal, such as a frequency at which a reflected voltage spike may be observed, and to remove noise. The voltage signal may next pass through comparator circuit 86, which may compare an amplitude and/or a change in amplitude of the voltage signal to a threshold to determine whether a voltage spike occurs. Whenever a voltage spike is detected, comparator circuit 86 may output a signal pulse to hold circuit 88. Hold circuit 88 may track each signal pulse and direct a corresponding output signal to ECU 58.

ECU 58 may use the output signal to determine a time at which a reflected voltage spike occurred. Thus, ECU 58 may determine a time at which a spark occurred. In certain embodiments. ECU 58 may also determine which ignition coil 53 of a plurality ignition coils connected to sensor circuit 60 (through capacitive coupling 80) is associated with a received output signal, based on engine timing, for example. As described below, ECU 58 may use the determination of a time at which a spark occurred to monitor operation of engine 10 and/or a condition of one or more components of ignition system 52, such as spark plug 54.

FIG. 4 depicts waveforms 110 and 120 associated with an exemplary ignition cycle that occurs under normal operating conditions. Waveform 110 may depict a secondary coil voltage, such as a voltage in a secondary coil 72 during an ignition cycle. At least one of high side switch 66 and low side switch 70 may be closed at time 112, which may cause a voltage difference across electrodes of spark plug 54, resulting in a spark at time 114. A time difference between times 112 and 114 may be the ignition cycle “spark time”. On the other hand, waveform 120 may depict a primary coil current during the same ignition cycle. As has been described, some detection systems may use a time 122 and a time 124, which may represent the times at which current is at 0% and 100% of a maximum value, respectively, to determine a rise time 126.

Spark time 116 and rise time 126 may both be used to determine a spark voltage (e.g., the voltage just before occurrence of a spark). However, spark time 116 allows for a more accurate determination of spark voltage than rise time 126, since spark time 116 is associated with the actual timing of a spark, while rise time 126 is merely an approximation of spark time 116. As shown in FIG. 4, rise time 126 may not be an accurate approximation of spark time 116, as time 124 may occur well after time 114 (the time at which the spark occurs). In some embodiments, ECU 58 may use a combination of spark time 116 and rise time 126 to determine spark time, such as to enhance reliability of detection system 59.

ECU 58 may be configured to determine a spark time for a given ignition cycle based on a signal received from sensor circuit 60 and other known timings. For example, ECU 58 may be configured to determine a time at which one or more of high side switch 66 and low side switch 70 is closed, determine a time at which sensor circuit 60 detected a spark, and determine a difference between these times, the time difference being the spark time. ECU 58 may determine the time at which sensor circuit 60 detected a spark based on a signal pulse received from sensor circuit 60, which may have been generated when a voltage signal exceeded a threshold (e.g., as determined by comparator circuit 86).

ECU 58 may be configured to determine a spark voltage based on the determined spark time, such as by using one or more algorithms, equations, maps and/or look-up tables that define a relationship between spark time and spark voltage. In certain embodiments, the spark voltage may be used to determine a condition of spark plug 54. For example, ECU 58 may compare the spark voltage to a threshold value. Based on the comparison, ECU 58 may determine whether spark plug 54 is in need of being replaced. Further, since spark time is used instead of rise time, a more accurate diagnosis of spark plug 54 may be made, promoting efficient use of spark plug 54 and reducing maintenance costs.

In addition, the exemplary disclosed configuration of detection system 59 further allows for consistent spark detection, even under adverse conditions, such as multi-arc conditions, low spark voltage conditions, and high spark voltage conditions. A multi-arc condition occurs when a spark plug produces multiple sparks (or arcs) during one ignition cycle. FIG. 5 depicts waveforms 130 and 140 associated with an exemplary ignition cycle that includes a multi-arc condition. Waveform 130 depicts a secondary voltage associated with the ignition cycle, showing that a spark time between a time 132 at which one or more of high side switch 66 and low side switch 70 closes and a time 134 at which a first spark occurs indicates a spark time 136 that is not affected by occurrence of subsequent sparks. On the other hand, waveform 140, which depicts a primary coil current associated with the same ignition cycle, shows that a time difference between a time 142 corresponding to 0% of maximum current and a time 144 corresponding to 100% of maximum current is affected by the occurrence of multiple sparks, resulting in a rise time 146 that is much different from spark time 136.

FIG. 5 shows that, under an adverse condition such as a multi-arc condition, use of spark time is more accurate than use of rise time for determining spark voltage. When a multi-arc condition occurs, ECU 58 may determine spark time by measuring a time between a closing of high side switch 66 and/or low side switch 70 and detection of a first occurrence of a spark of the plurality of spark occurrences during the same ignition cycle. ECU 58 may determine the time of the first occurrence of a spark based on an output signal received from sensor circuit 60. Sensor circuit 60, being configured to measure voltage on low side 78 of primary coil 68, may consistently detect the first occurrence of a spark. Thus, ECU 58 may consistently and accurately determine spark voltage, even under a multi-arc condition.

Low spark voltage conditions may correspond to situations in which there is an abnormally short period of time between initiation of an ignition cycle and occurrence of a spark. Similarly, high spark voltage conditions may correspond to situations in which there is an abnormally long period of time between initiation of an ignition cycle and occurrence of spark. Low spark voltage conditions and high spark voltage conditions may be caused, for example, by a new spark plug being used, combustion turbulence, high engine loads, and/or other adverse conditions. FIGS. 6 and 7 depict waveforms which indicate that sensor circuit 60 may determine a time at which a spark occurs under low and high spark voltage conditions, respectively.

FIG. 6 depicts waveforms 210 and 220 associated with an exemplary ignition cycle that occurs under a low spark voltage condition. Waveform 210 depicts a secondary voltage associated with the ignition cycle, and waveform 220 depicts an output signal associated with sensor circuit 60. Waveform 210 shows that, after a time 212 at which one or more of high side switch and low side switch 70 closes, a spark occurs at a time 214 shortly thereafter, indicating an abnormally short spark time 216. Waveform 220 shows that a signal pulse 222 is output at the time that the spark occurs. ECU 58 may receive signal pulse 222 and determine spark time 216. In this way, sensor circuit 60, by measuring a voltage on a low side 78 of primary coil 68, may consistently output a signal pulse indicating a time at which a spark occurs, even under a low spark voltage condition. For example, sensor circuit 60 may detect a spark even when the spark occurs less than 80 μs after high side switch 66 and low side switch 70 are closed to cause the spark to occur. In some embodiments, sensor circuit 60 may detect a spark even when the spark occurs as low as 10 us after high side switch 66 and low side switch 70 are closed.

FIG. 7 depicts waveforms 230 and 240 associated with an exemplary ignition cycle that occurs under a high spark voltage condition. Waveform 230 depicts a secondary voltage associated with the ignition cycle, and waveform 240 depicts an output signal associated with sensor circuit 60. Waveform 230 shows that, after a time 232 at which high side switch 66 and low side switch 70 close, a spark occurs at a time 234 a relatively long period of time thereafter, indicating an abnormally long spark time 236. Waveform 240 shows that a signal pulse 242 is output at the time that the spark occurs. ECU 58 may receive signal pulse 242 and determine spark time 236. In this way, sensor circuit 60, by measuring a voltage on a low side 78 of primary coil 68, may also consistently output a signal pulse indicating a time at which a spark occurs, even under a high spark voltage condition. For example, sensor circuit 60 may detect a spark even when the spark occurs more than 140 us after high side switch 66 and low side switch 70 are closed to cause the spark to occur.

It will be apparent to those skilled in the art that various modifications and variations can be made to the detection system of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A method for determining spark voltage of a spark plug in a capacitive discharge ignition system, comprising:
measuring a voltage on a low side of a primary coil;
determining a spark time based on the voltage; and
determining a spark voltage based on the spark time.

2. The method of claim 1, wherein measuring the voltage on the low side of the primary coil includes measuring voltage between a primary winding and a low-side switch.

3. The method of claim 2, wherein measuring voltage on the low side of the primary coil further includes measuring voltage at a low-side pin of the primary coil.

4. The method of claim 1, wherein measuring the voltage on the low side of the primary coil includes measuring voltage in the vicinity of a current sensing resistor.

5. The method of claim 4, wherein measuring the voltage on the low side of the primary coil includes measuring voltage directly at the current sensing resistor.

6. The method of claim 1, wherein determining spark time includes:
determining a first time at Which a switch is closed;
determining a second time at which the voltage exceeded a threshold; and
determining a time difference between the first time and the second time.

7. The method of claim 1, wherein the voltage is measured under an adverse condition.

8. The method of claim 7, wherein the adverse condition is a multi-arc condition, and determining the spark time includes measuring a time between closing of a switch and detection of a first occurrence of a spark of a plurality of spark occurrences caused by the closing of the switch.

9. The method of claim 7, wherein the adverse condition is a low spark voltage condition in which a spark occurs less than 80 μs after a switch is dosed to cause the spark.

10. The method of claim 7, wherein the adverse condition is a high spark voltage condition in which a spark occurs more than 140 us after a switch is closed to cause the spark.

11. The method of claim 1, further including comparing the spark voltage to a threshold, and determining a condition of the spark plug based on the comparison.

12. A detection system for determining spark voltage of a spark plug in a capacitive discharge ignition system, comprising:
a sensor circuit configured to detect occurrence of a spark by measuring a voltage on a low side of a primary coil; and
an electronic control unit connected to the sensor circuit,
wherein the electronic control unit is configured to:
receive a signal from the sensor circuit indicating that the voltage exceeded a threshold;
determine a spark time based on the signal; and
determine a spark voltage based on the spark time.

13. The detection system of claim 12, wherein the sensor circuit is connected between a primary winding of the primary coil and a low-side switch.

14. The detection system of claim 13, wherein the sensor circuit is directly connected to a low-side pin of the primary coil.

15. The detection system of claim 12, wherein the sensor circuit is connected near a current sensing resistor to measure the voltage in a vicinity of the current sensing resistor.

16. The detection system of claim 15, wherein the sensor circuit is directly connected at the current sensing resistor.

17. The detection system of claim 12, wherein the sensor circuit is connected to a plurality of primary coils by a capacitive coupling, and is configured to individually measure a voltage of each of the plurality of primary coils.

18. The detection system of claim 17, wherein the electronic control unit is further configured to determine which of the plurality of primary coils is associated with a received signal indicating that a measured voltage exceeded a threshold.

19. The detection system of claim 12, wherein the sensor circuit includes a comparator circuit and a hold circuit.

20. The detection system of claim 19, wherein the sensor circuit further includes a primary filter, a primary amplifier, a secondary filter, and a secondary amplifier.

21. The detection system of claim 12, wherein:
the electronic control unit is connected to a switch, and
the electronic control unit is configured to measure the spark time by measuring a time between closing of the switch and detection by the sensor circuit of a first occurrence of a spark of a plurality of spark occurrences caused by the closing of the switch.

22. The detection system of claim 12, wherein the sensor circuit is configured to output the signal indicating that the voltage exceeded the threshold less than 80 after a switch is closed to cause the spark.

23. The detection system of claim 12, wherein the sensor circuit is configured to output the signal indicating that the voltage exceeded the threshold more than 140 μs after a switch is closed to cause the spark.

24. An engine, comprising:
a combustion chamber;
a spark plug configured to selectively ignite a fuel mixture within the combustion chamber by generating a spark;
an ignition coil configured to supply high voltage electricity to the spark plug for generating the spark, the ignition coil including a primary coil and a secondary coil; and
a detection system, the detection system including:
a sensor circuit connected to a low side of the primary coil and configured to detect occurrence of a spark by measuring a voltage on the low side of the primary coil; and
an electronic control unit configured to:
receive a signal from the sensor circuit indicating that the voltage exceeded a threshold;
determine a spark time based on the signal; and
determine a spark voltage based on the spark time.
